(19) United States
(12) Patent Application Publication
(10) Pub. No.: US 2020/0384672 A1
(43) Pub. Date: Dec. 10, 2020

(54) MOTOR VEHICLE COMPOSITE COMPONENT AND METHOD FOR THE PRODUCTION THEREOF

(71) Applicant: KRALLMANN KUNSTSTOFFVERARBEITUNG GMBH, Hiddenhausen (DE)

(72) Inventors: Ingo BREXELER, Wetter/Ruhr (DE); Thorsten MICHEL, Lautert (DE)

(21) Appl. No.: 16/314,019

(22) PCT Filed: Jun. 27, 2017
(86) PCT No.: PCT/EP2017/000745

§ 371 Date: May 17, 2019

(30) Foreign Application Priority Data
Jun. 30, 2016 (DE) 10 2016 007 913.4

(51) Int. Cl. B29C 44/08; B22D 19/00; B29C 44/44; B29C 45/16

(52) U.S. Cl. CPC B29C 44/083; B22D 19/00; B29C 44/445; B29C 44/1266; B29C 2045/169; B29C 2045/1696; B29C 45/1635

(57) ABSTRACT

To manufacture a motor vehicle composite component, plastic particles are introduced into a mold cavity of a mold and are connected there to one another to form a particle foam. The mold is then adjusted while the mold cavity changes, and a thermoplastic plastic is then injected into the mold cavity while a carrying element and/or at least one fastening element are formed, wherein the thermoplastic plastic is bonded to the particle foam at least by connection in substance. The aforementioned materials may also be introduced in the reverse order. The mold is then adjusted once again while the mold cavity changes, and a metal melt is then injected into the mold cavity, as a result of which an electrical strip conductor and/or at least one metallic fastening element are formed.

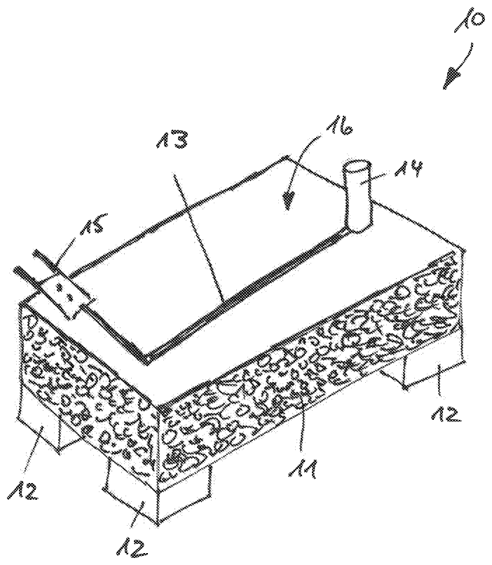

### CROSS REFERENCE TO RELATED APPLICATIONS

This application is a United States National Phase Application of International Application PCT/EP2017/000745 filed Jun. 27, 2017, and claims the benefit of priority under 35 U.S.C. § 119 of German Application 10 2016 007 913.4, filed Jun. 30, 2016, the entire contents of which are incorporated herein by reference.

### TECHNICAL FIELD

The present invention pertains to a motor vehicle composite component as well as to a process for manufacturing same. The motor vehicle composite component is especially a motor vehicle composite component visible in the installed state with an integrated electrical connectivity, for example,
a car door with integration of functional elements, such as a power window, a door lock, a loudspeaker, a light, a switch for a mirror, a switch for a roof, a vent duct, an air bag, etc.,
a shock absorber with integration of sensors for park assist, of crash sensors or sensors for air bag deployment,
a rocker panel trim,
a spoiler with integration of antennas, sensor systems or lighting,
a center console,
an arm rest,
a sun visor,
a dashboard,
an interior roof lining,
a carrying vertical pillar (A pillar or B pillar), or
a trunk trim or interior trim.

### TECHNICAL BACKGROUND

The following description will be based as an example on a component for building a carrying structure of a vehicle door. A vehicle door of a conventional configuration has a carrier system made of steel, which is covered by a sheet metal on the outer side. An aggregate carrier system, which is usually manufactured from metal or plastic separately, is manufactured for the interior trim of the vehicle door, and electrical or electronic components, such as a power window, a lock, a loudspeaker, etc., are fastened in the carrier system by screwing, bonding, riveting, snapping in, etc. An interior trim made of textile, leather or plastic is applied and fastened in another working step. A plastic foam element, which is used for heat and sound insulation and may be provided on its surface with an additional skin or even with a prefabricated laminate layer, is additionally mounted in many cases on the aggregate carrier system.

The manufacture of a corresponding motor vehicle composite component requires a plurality of different working steps and is consequently both very time-consuming and costly.

### SUMMARY

A basic object of the present invention is to provide a process for manufacturing a motor vehicle composite component of the aforementioned type, with which a corresponding composite component can be manufactured in a simplified manner. Moreover, a corresponding motor vehicle composite component shall be created.

This object is accomplished concerning the process in a first alternative by a process in which plastic particles are first introduced here into a mold cavity of a mold and bonded there to one another into a particle foam while applying thermal energy. The mold is then adjusted while the mold cavity changes, and a thermoplastic plastic is then injected into the mold cavity while at least one carrier element and/or at least one fastening element are formed, while the thermoplastic plastic is bonded to the particle foam at least by connection in substance. The mold is then adjusted once again while changing the mold cavity, and a metal melt is then injected into the mold cavity, as a result of which at least one electrical strip conductor and/or at least one metallic fastening element are formed.

Provisions are made in an alternative embodiment of the process according to the invention for a thermoplastic plastic being first injected into a mold cavity of a mold while at least one carrier element and/or at least one fastening element are formed. Then, while the mold cavity changes, the mold is adjusted, and plastic particles are subsequently introduced into the mold cavity and are bonded to one another there while supplying thermal energy to form a particle foam, while the thermoplastic plastic is bonded to the particle foam at least by connection in substance. The mold is then adjusted once again while the mold cavity changes, and a metal melt is subsequently injected into the mold cavity, as a result of which at least one electrical strip conductor and/or at least one metallic fastening element are formed.

The above-mentioned two processes differ from each other in this manner essentially in the order in which the materials are introduced. While the particle foam is first formed and the thermoplastic plastic is then injected onto this in the process mentioned first, the thermoplastic plastic is injected first into the mold cavity and the plastic particles are then introduced into the mold cavity and a particle foam, which is bonded to the thermoplastic plastic, is formed in the second process.

The term “connection in substance” is defined as a connection by which the components to be bonded are held together by atomic or molecular forces.

Provisions may preferably be made for prefabricated reinforcing elements to be inserted into the mold cavity prior to the insertion of the plastic particles and then to be embedded in the particle foam. The reinforcing elements may be, for example, plastic fibers and/or natural fibers and/or at least one network of plastic or metal or at least one grid consisting of plastic or metal.

Provisions may be made in a variant of the present invention for prefabricated connection elements to be inserted into the mold cavity prior to the insertion of the plastic particles and then to be embedded in the particle foam.

As an alternative or in addition to this, provisions may be made for prefabricated connection elements to be inserted into the mold cavity prior to the insertion of the thermoplastic plastic and then to be embedded in the thermoplastic plastic.

The connection elements may be, for example, screws and/or threaded rods and/or clips.

Provisions are made in an especially preferred embodiment of the present invention for the particle foam to be formed with a closed-cell surface. The type and the surface structure of the closed-cell surface can be set by correspondingly selecting the process parameters. Smooth or structured or soft surfaces, which meet the aesthetic requirements of the manufacturer, can be obtained in this manner as desired, so that complicated postprocessing operations can be eliminated.

In addition to the connection in substance between the particle foam and the thermoplastic plastic, a positive-locking connection may also be given between these materials, for example, due to undercuts or penetrations.

As was already explained, the motor vehicle composite component is manufactured in an integrated particle foam-metal injection process, wherein a particle foam, a thermoplastic plastic, a metal melt and optionally reinforcing fibers, fiber composites and fastening elements are inserted into a single mold and are bonded to one another, while the particle foam, in particular, acquires a desired surface configuration. A subsequent fitting together, mounting or welding can be eliminated as a result to the greatest extent possible or altogether. A combined finished component with integrated electrical and electronic connection possibility can be manufactured in this manner.

The process connects in one operation the steps that were hitherto carried out separately and at different times. Separate fastening elements consisting of different materials are not needed any longer, and the connection functions are integrated in the composite component, as a result of which the subsequent assembly processes are shortened and simplified. Moreover, assembly errors are avoided, which leads to marked cost savings. The composite component has a low weight and at the same time a high absorption capacity for noises and for the effect of external forces, and it additionally has very good heat insulation.

The particle foam has not only a filling function, but it also forms an elementary component of the composite component, which has carrying and filling functions, which is used for fastening, has a heat- and sound-absorbing effect and additionally also has protective, trimming, decorative and haptic functions. Moreover, the particle foam is used as an electrical insulator.

All electrical strip conductors as well as necessary metallic fastening elements are preferably inserted into the particle foam and/or into the thermoplastic plastic by means of the metal injection process, so that the subsequent insertion of power cables or the fitting of the composite component with clips, screws, etc., is no longer necessary.

Functional elements, operating elements or frame structures can be formed by the injection of the thermoplastic plastic. The inserted reinforcing elements are used to reinforce the composite component, and fibers or fiber composites may also be injected simultaneously with the thermoplastic plastic.

To accomplish the above-described object, the vehicle composite component has a carrier consisting of plastic particle foam, which is connected in substance to carrier elements and/or fastening elements consisting of a thermoplastic plastic, as well as at least one electrical strip conductor and/or at least one metallic fastening element.

Further features of the motor vehicle composite component appear from the following description of the process. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The only FIGURE is a perspective sectional view showing a motor vehicle composite component in a simplified manner.

### DESCRIPTION OF PREFERRED EMBODIMENTS

Referring to the drawings, a motor vehicle composite component 10 has a carrier 11 made of a plastic particle foam, which is formed at least on a motor vehicle composite component surface with a closed-cell surface 16.

The carrier 11 is connected in substance to the carrying element and/or fastening element 12 consisting of a thermoplastic plastic.

At least one strip conductor 13, which interacts with metallic fastening elements 14, 15, is formed on the carrier 11.

To manufacture the motor vehicle composite component 10, plastic particles are introduced into a mold cavity of a mold and are connected there to one another to form a particle foam. The mold is then adjusted while the mold cavity changes, and a thermoplastic plastic is then injected into the mold cavity while a carrying element and/or the at least one fastening element 12 are formed, wherein the thermoplastic plastic is bonded to the particle foam at least by connection in substance. The aforementioned materials may also be introduced in the reverse order. The mold is then adjusted once again while the mold cavity changes, and a metal melt is then injected into the mold cavity, as a result of which the electrical strip conductor 13 and/or at least one metallic fastening element 14, 15 are formed.

While specific embodiments of the invention have been shown and described in detail to illustrate the application of the principles of the invention, it will be understood that the invention may be embodied otherwise without departing from such principles.

1. A process for manufacturing a motor vehicle composite component, the process comprising the steps of:
introducing plastic particles into a mold and bonding the plastic particles to one another in the mold into a particle foam while supplying thermal energy;
subsequent to said step of introducing and bonding, adjusting the mold while the mold cavity changes, and injecting a thermoplastic plastic into the mold cavity while at least one carrying element and/or at least one fastening element is formed, wherein the thermoplastic plastic is bonded to the particle foam at least by connection in substance;
subsequent to said step of adjusting and injecting, adjusting the mold while the mold cavity changes, and injecting a metal melt into the mold cavity, as a result of which at least one electrical strip conductor and/or at least one metallic fastening element are formed.

2. A process for manufacturing a motor vehicle composite component, the process comprising the steps of:
injecting a thermoplastic plastic into a mold cavity of a mold while at least one carrying element and/or at least one fastening element are formed, after which
subsequent to said step of injecting, adjusting the mold while the mold cavity changes;
subsequent to said step of adjusting, introducing plastic particles into the mold cavity and in the cavity bonding the plastic particles to one another into a particle foam while supplying thermal energy, wherein the thermoplastic plastic is bonded to the particle foam at least by connection in substance;
subsequent to said step of introducing and bonding, adjusting the mold while the mold cavity changes; and subsequently injecting a metal melt into the mold cavity, as a result of which at least one electrical strip conductor and/or at least one metallic fastening element are formed.

3. A process for manufacturing a motor vehicle composite component in accordance with claim 2, wherein prefabricated reinforcing elements are inserted into the mold cavity before the introduction of the plastic particles and they are then embedded in the plastic foam.

4. A process for manufacturing a motor vehicle composite component in accordance with claim 3, wherein the reinforcing elements are formed by synthetic fibers and/or natural fibers and/or at least one network or at least one grid consisting of plastic or metal.

5. A process for manufacturing a motor vehicle composite component in accordance with claim 2, wherein prefabricated connection elements are inserted into the mold cavity before the introduction of the plastic particles and are then embedded in the particle foam.

6. A process for manufacturing a motor vehicle composite component in accordance with claim 2, wherein prefabricated connection elements are inserted into the mold cavity before the introduction of the thermoplastic plastic and are then embedded in the thermoplastic plastic.

7. A process for manufacturing a motor vehicle composite component in accordance with claim 5, wherein the connection elements are formed by screws and/or threaded rods and/or clips.

8. A process for manufacturing a motor vehicle composite component in accordance with claim 7, wherein the particle foam is formed with a closed-cell surface.

9. A process in accordance with claim 2, wherein the thermoplastic plastic is additionally bonded to the particle foam in a positive-locking manner.

10. A motor vehicle composite component comprising:
a carrier consisting of a plastic particle foam;
carrying elements and/or fastening elements consisting of a thermoplastic plastic, wherein the carrier is bonded to carrying elements and/or fastening elements consisting of a thermoplastic plastic by a connection in substance; and
at least one electrical strip conductor and/or at least one metallic fastening element.

11. A motor vehicle composite component in accordance with claim 10, wherein the particle foam is formed with a closed-cell surface.

12. A process for manufacturing a motor vehicle composite component in accordance with claim 6, wherein:
the connection elements are formed by screws and/or threaded rods and/or clips; and
the particle foam is formed with a closed-cell surface.

13. A process for manufacturing a motor vehicle composite component in accordance with claim 1, wherein prefabricated reinforcing elements are inserted into the mold cavity before the introduction of the plastic particles and they are then embedded in the plastic foam.

14. A process for manufacturing a motor vehicle composite component in accordance with claim 13, wherein the reinforcing elements are formed by synthetic fibers and/or natural fibers and/or at least one network or at least one grid consisting of plastic or metal.

15. A process for manufacturing a motor vehicle composite component in accordance with claim 1, wherein prefabricated connection elements are inserted into the mold cavity before the introduction of the plastic particles and are then embedded in the particle foam.

16. A process for manufacturing a motor vehicle composite component in accordance with claim 1, wherein prefabricated connection elements are inserted into the mold cavity before the introduction of the thermoplastic plastic and are then embedded in the thermoplastic plastic.

17. A process for manufacturing a motor vehicle composite component in accordance with claim 16, wherein the connection elements are formed by screws and/or threaded rods and/or clips.

18. A process for manufacturing a motor vehicle composite component in accordance with claim 17, wherein the particle foam is formed with a closed-cell surface.

19. A process in accordance with claim 1, wherein the thermoplastic plastic is additionally bonded to the particle foam in a positive-locking manner.

20. A process for manufacturing a motor vehicle composite component in accordance with claim 15, wherein:
the connection elements are formed by screws and/or threaded rods and/or clips; and
the particle foam is formed with a closed-cell surface.
